(19) United States
(12) Patent Application Publication
(10) Pub. No.: US 2006/0112052 A1
(43) Pub. Date: May 25, 2006

(54) Methods and systems for managing knowledge documents

(76) Inventors: Anne Hicks Jeanblanc, Elizabeth, IL (US); James Michael Coffey, Dunlap, IL (US); Benjamin Eugene Newman, Kewanee, IL (US); Reed Alfred Stuedemann, East Peoria, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/261,576

(22) Filed: Oct. 31, 2005

Related U.S. Application Data
(63) Continuation-in-part of application No. 09/995,822, filed on Nov. 29, 2001.

(51) Int. Cl. G06N 5/02

(52) U.S. Cl. 706/46

(57) ABSTRACT

Methods and systems for managing knowledge documents in a community of practice environment are disclosed. In one embodiment, a community of practice environment may include a set of communities of practice, each including respective members and each being assigned respective knowledge documents. The community of practice environment may also include a database system storing the knowledge documents used by the communities of practice. The database system may be configured to deliver copies of the knowledge documents to the communities of practices in response to requests to access the knowledge documents from respective community of practice members.

### CROSS REFERENCE TO RELATED APPLICATIONS

This application is a continuation-in-part of U.S. patent application Ser. No. 09/995,822, filed Nov. 29, 2001, entitled “Knowledge Management System and Method,” which is incorporated herein by reference in its entirety.

Further, this application is related to U.S. patent application Ser. No. ______, filed ______, entitled METHODS AND SYSTEMS FOR PROVIDING KNOWLEDGE DOCUMENTS (Attorney Docket No. 08350.5679), U.S. patent application Ser. No. ______, filed ______, entitled METHODS AND SYSTEMS FOR COLLABORATING COMMUNITIES OF PRACTICE (Attorney Docket No. 08350.5680), and U.S. patent application Ser. No. ______, filed ______, entitled METHODS AND SYSTEMS FOR DELIVERING COMMUNITY KNOWLEDGE (Attorney Docket No. 08350.5681), each of which is incorporated by reference in its entirety.

### TECHNICAL FIELD

The present invention relates generally to knowledge management, and more particularly, to a method and system for gathering, managing, and sharing knowledge in a community of practice.

### BACKGROUND

Organizations, such as businesses, often rely heavily on knowledge within the organization itself. One example of this reliance is training. Experienced employees are often called upon to train new employees. In addition to training the new employee how to do the job, the experienced employee may also share advice based on lessons the experienced employee learned by doing the same job. Another example is a “resident expert.” Often an employee, through education or experience or both, has become particularly knowledgeable about a topic. Other employees who need advice or information about this topic may contact the “resident expert.” Other examples of important corporate knowledge are internal standards. Internal standards for a procedure or product may be generated and updated by the persons in the organization who are responsible for the procedure or product. The internal standards may be used by the responsible team to ensure that procedures and policies are followed. Further, the internal standards may be used as a guide to quickly train new members of the team. Finally, internal standards may be used by other divisions of the organization as a basis for forming their own standards or for interacting with the responsible team.

Organizational knowledge may be very valuable to an organization. A number of problems exist, however, which may cause the organization to not fully utilize, or even realize the extent of, this organizational knowledge. One problem is that organizational knowledge is often not captured from the knowledgeable employee and documented for use by others. Unless knowledge is documented, it is possible that others within the organization will not be able to determine where particular organizational knowledge resides, and thus the knowledge will be underutilized. Additionally, if a knowledgeable employee leaves the organization without first documenting his knowledge, that knowledge will be lost to the organization. Another problem is that, while an employee may be particularly knowledgeable, until that knowledge has been identified, other persons in the organization (including in other divisions of the organization) may be unaware of the existence of the “resident expert.”

Further, many organizations are becoming increasingly globalized. For example, one company may have corporate headquarters located in one state, research and development facilities located in a second state, manufacturing operations in a number of other states, and retail facilities worldwide. Part of the reason for this globalization is the ease with which communications between these locations may occur. While the technology exists to permit interaction and collaboration among persons at different locations in the organization, current systems do not provide sufficient structure to identify sources of knowledge and enable interaction between persons having knowledge and persons seeking knowledge. Not only does the organizational knowledge need to be globally accessible, but interaction must also be supported.

Finally, in addition to merely capturing the knowledge, it is most effective to provide for interaction and collaboration based on the knowledge. Rather than simply requesting persons to submit any knowledge that they might have, even if directed to a particular topic, it is effective to instead focus the interested persons on a project, goal, or purpose. From the interaction and collaboration that follows based on the project, the knowledge can be captured and documented.

In addition to systems that permit limited interaction, systems also exist that permit some documentation of organizational knowledge. Some of these systems may include mere cataloging of information or mere answering of questions. These systems, however, are limited to a single facet of knowledge, such as “best practices” or internal standards. The systems may also be limited in the persons that may participate. Additionally, these systems are often relatively static and non-interactive. For example, some of these systems may be simply a list of frequently asked questions. At best, some systems refer a user to the person who supplied the knowledge that the user is accessing. The currently available systems do not provide sufficient interaction and/or collaboration with other users to achieve a common purpose based on the knowledge, nor do the current systems provide a dynamic, constantly updating knowledge system. One exemplary existing system is described in U.S. Pat. No. 5,924,072, entitled “Knowledge Management System and Method.” This system provides for the submission of knowledge items by a user, as well as the use of the knowledge items by a second user. The second user may submit feedback about the knowledge item. However, there is no interaction or collaboration between the users; further, the system is designed merely to acquire knowledge.

Additionally, existing systems do not provide an environment that enables knowledge to be shared while managing the number of resources used in providing access to the knowledge.

The present invention is directed to overcoming one or more of the problems or disadvantages associated with the prior art.

### SUMMARY OF THE INVENTION

Methods and systems for managing knowledge documents in a community of practice environment is disclosed. In one embodiment, a community of practice environment may include a set of communities of practice, each including respective members and each being assigned respective knowledge documents. The community of practice environment may also include a database system storing the knowledge documents used by the communities of practice. The database system may be configured to deliver copies of the knowledge documents to the communities of practices in response to requests to access the knowledge documents from respective community of practice members.

In another embodiment, a method for managing knowledge documents in a community of practice environment including communities of practices is disclosed. The method may include assigning knowledge documents to respective communities of practice. Each community of practice may include members that use the knowledge documents to achieve a goal of the community of practice and a computer system that stores information reflecting the knowledge document assignments. The method may also include storing the knowledge documents in a memory space accessible by each of the communities of practice.

It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate exemplary embodiments of the invention and together with the description, serve to explain the principles of the invention. In the drawings:

FIG. 1 is a block diagram of an exemplary community of practice consistent with one embodiment of the present invention;

FIG. 2 is a block diagram of an exemplary knowledge management architecture consistent with one embodiment of the present invention;

FIG. 3 is a block diagram of an exemplary knowledge management system consistent with one embodiment of the present invention;

FIG. 4 is an exemplary flow chart illustrating a method for creating a community of practice, consistent with one embodiment of the present invention;

FIG. 5 is an exemplary flow chart illustrating a method for managing knowledge, consistent with one embodiment of the present invention;

FIG. 6 is a block diagram of an exemplary community of practice environment, consistent with certain disclosed embodiments;

FIG. 7 is a block diagram of an exemplary memory space, consistent with certain disclosed embodiments;

FIG. 8 is a block diagram of an exemplary community of practice environment including a process flow for managing knowledge documents, consistent with certain disclosed embodiments;

FIG. 9 is a block diagram of an exemplary community of practice environment including additional process flows for managing knowledge documents, consistent with certain disclosed embodiments;

FIG. 10 is a flowchart of an exemplary community of practice membership process, consistent with certain disclosed embodiments;

FIG. 11 is a flowchart of an exemplary knowledge document addition process, consistent with certain disclosed embodiments; and

FIG. 12 is a flowchart of an exemplary knowledge document delivery process, consistent with certain disclosed embodiments.

### DETAILED DESCRIPTION

Reference will now be made in detail to embodiments of the invention, examples of which are illustrated in the accompanying drawings. Wherever possible, the same reference numbers will be used throughout the drawings to refer to the same or like parts.

A system and method are provided to capture, manage, and share knowledge within an organization. The system and method of the present invention are not limited to knowledge management within an organization, but may be used to facilitate the capture, management, and sharing of knowledge within any organized group of persons working for common goals or purposes. Specifically, a community of practice is formed to facilitate the capturing, managing, and sharing of knowledge. A community of practice is a group of persons (most typically in a single organization) grouped together for a common purpose or to achieve a common goal. For example, a community of practice may be formed to develop a training program for employees in a division, or to create a set of standards for a new product line. A community of practice is not necessarily based on formal divisions within the organization, but may include members from many divisions who are involved in an aspect of the organization or a particular project. Also included in the community of practice is a set of procedures, best practices and standards that the community of practice can use in working towards the purpose or goal. After the goal or purpose is accomplished, the community of practice can continue as an organizational resource.

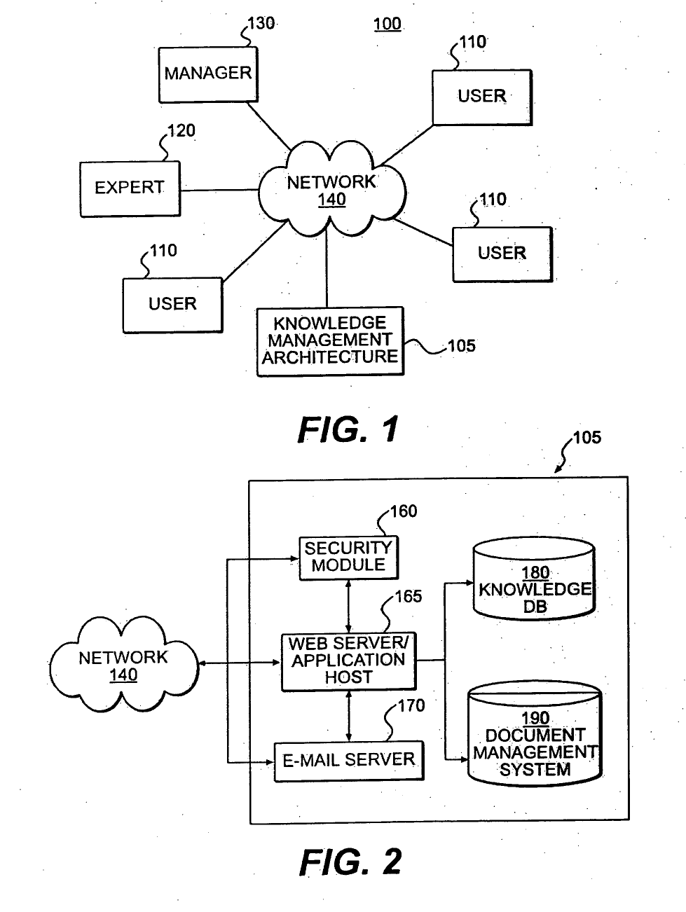

FIG. 1 illustrates an exemplary community of practice 100, consistent with one embodiment of the present invention. As shown in FIG. 1, community of practice 100 includes a knowledge management architecture 105, a plurality of users 110, an expert 120, and a community of practice manager 130, all interconnected by network 140. Knowledge management architecture 105 facilitates interaction among the participants (namely, users 110, expert 120, and manager 130) in community of practice 100. Knowledge management architecture 105 also maintains knowledge entries. Users 110 interact with other users 110, expert 120, and community of practice manager 130 via network 140, for example, by posing questions or responding to the questions of others. Users 110 may also, access knowledge entries via knowledge management architecture 105. Further, users 110 may submit their own knowledge to be added to knowledge management architecture 105. Users 110 may interface with community of practice 100 using personal computers, work stations, or other devices connected to network 140.

Expert 120 is similar to user 110, but has been identified within community of practice 100 as having special knowledge. Users 110 may obtain the status of expert 120 through, inter alia, significant participation in a community of practice. In addition to interacting with other entities in community of practice 100 and submitting and accessing knowledge, expert 120 may participate in approving knowledge submitted by users 110. Although only one expert 120 is illustrated in FIG. 1, community of practice 100 may include a plurality of experts.

Community of practice manager 130 functions as the facilitator and moderator for community of practice 100. Community of practice manager 130 may be responsible for review, validation, and dissemination of knowledge in the community of practice. Community of practice 100 may include one or more community of practice managers.

Network 140 may be the Internet, a wireless local area network (LAN), or another type of network. Network 140 is intended in its broadest sense to encompass any communications system.

FIG. 2 is a block diagram illustrating an exemplary knowledge management architecture 105. Knowledge management architecture 105 may include a security module 160, a Web server/application host module 165, an e-mail server 170, a knowledge database 180, and a document management system 190. Security module 160, Web server module 165, and e-mail server 170 interface with network 140. Web server module 165 is connected to e-mail server 170. Web server module 165 is also connected to knowledge database 180 and document management system 190. It is contemplated that a knowledge management system of the present invention may include some or all of the components of FIG. 2.

Security module 160 may determine what type of access each entity in community of practice 100 has with respect to knowledge database 180 and/or the document management system 190. For example, users 110 may access knowledge in knowledge database 180 but may not alter the knowledge. Further, users 110 who wish to add knowledge to knowledge database 180 may require approval of the knowledge before the knowledge is added. Expert 120 and/or community of practice manager 130, on the other hand, may be permitted access to knowledge database 180, as well as the ability to alter knowledge database 180. Further, security module 160 may be used to permit different levels of access to different users, based on, for example, subscription status. For example, anonymous users 110 may be permitted access to only a portion of knowledge database 180, whereas registered users 110 may access the entire knowledge database. While security is important, access is important to achieve interaction and collaboration, and security should be minimized if possible.

Web server/application host module 165 includes an interface for entities to access knowledge database 180, as well as document management system 190. Further, web server module 165 may include additional capabilities, such as collaboration tools to permit entities in community of practice 100 to work together, bulletin boards to permit entities in community of practice 100 to communicate with each other, and/or search engines to provide efficient access to specific knowledge entries in knowledge database 180 or document management system 190. Web server module 165 may also permit entities in community of practice 100 to submit knowledge to be added to knowledge base 180. An exemplary web server application is ColdFusion® by Allaire.

E-mail server 170 provides users 110, expert 120, and community of practice manager 130 with updated information from knowledge management architecture 105. For example, when a new knowledge entry has been approved, e-mail server 170 may forward the knowledge entry to the other entities in the community of practice 100. Alternatively, e-mail server 170 may forward notice of the availability of a new knowledge entry, tool, or standard that may be accessed using Web server module 165.

Knowledge database 180 contains approved knowledge entries, standards, tools, and other information used by entities in community of practice 100. Knowledge management architecture 105 may include one or more knowledge databases 180.

Document management system 190 provides access to documents stored in a number of different formats, such as word processing format, spread sheet format, or presentation format. Document management system 190 permits more rapid capture of knowledge, because documents do not need to be converted before they can be shared with the community of practice.

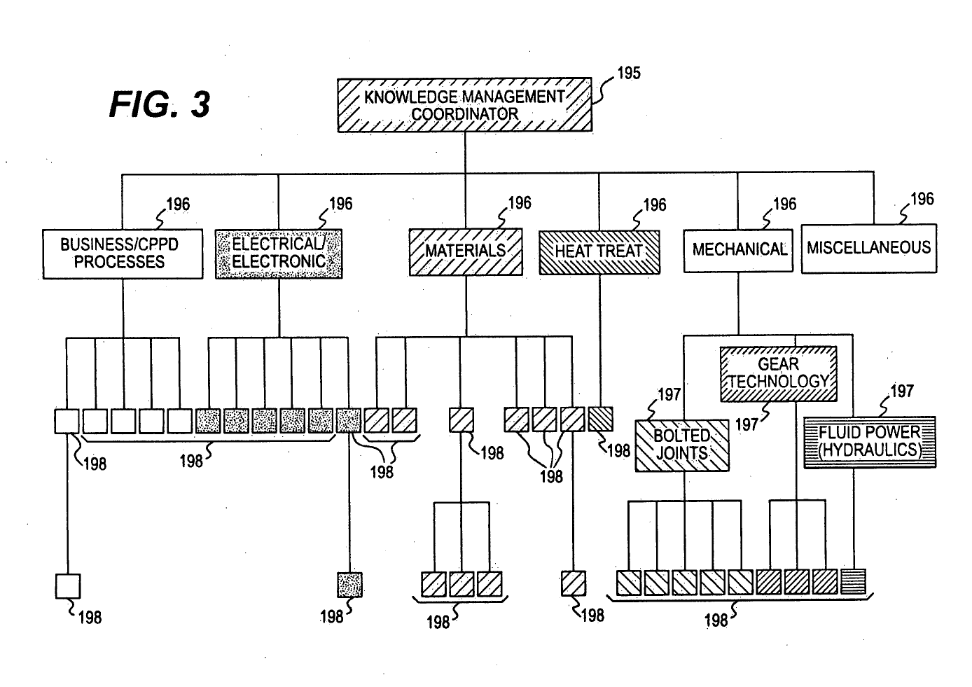

FIG. 3 illustrates an exemplary knowledge management system for an organization, consistent with one embodiment of the present invention. For example, the knowledge management system may include a knowledge management coordinator 195, one or more community groups 196, and one or more communities of practice 198. The one or more community groups may also include one or more sub-community groups 197. Knowledge management coordinator 195 oversees community groups 196 and communities of practice 198. Community groups 196 are logical divisions that may facilitate operation of communities of practice 198 by grouping communities of practice 198 with similar interests or goals. In the exemplary knowledge management system of FIG. 3, the community groups 196 include “Business/CPPD Processes,” “Electrical/Electronic,” “Materials,” “Heat Treat,” “Mechanical,” and “Miscellaneous.” As illustrated in FIG. 3, the “Mechanical” community group may include sub-community groups 197, which include more specific subject areas.

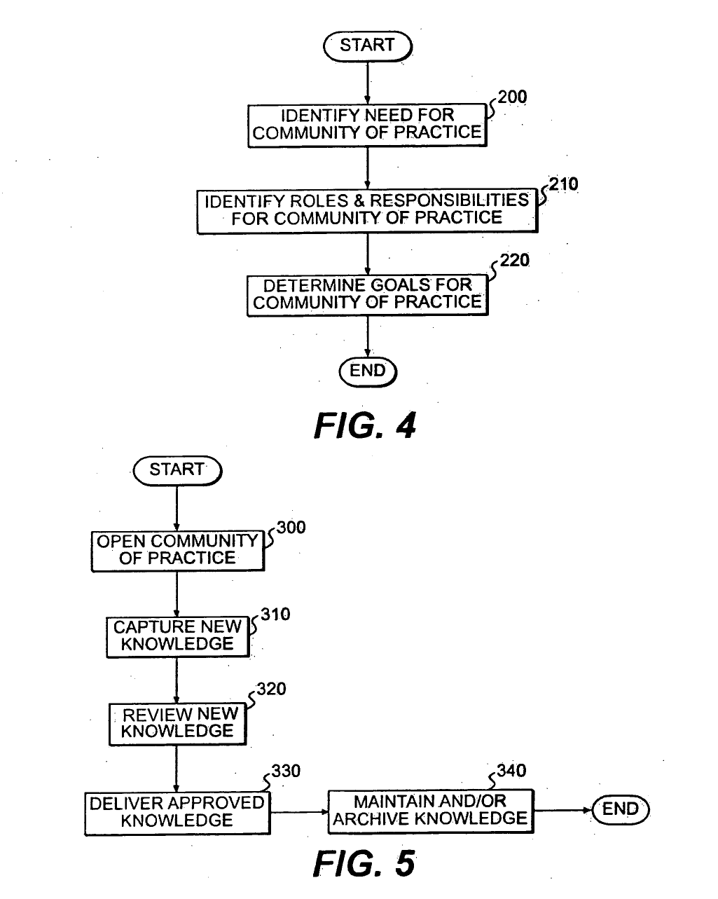

FIG. 4 illustrates an exemplary flow chart of a method for establishing a community of practice. First, a need for a community of practice is identified, for example, by identifying knowledge building activities (step 200). Knowledge building activities may include any activity where problems may be identified, solutions may be generated, or any other body of knowledge may be gathered or created. For example, knowledge building activities may include problem-solving activities, team meetings, firm-wide retreats, or new product designs or launches. A knowledge management coordinator, who may oversee the operation of a number of communities of practice for the organization, may be notified of the new community of practice and may assist with the formation of the new community of practice.

Next, the roles and responsibilities of the community of practice are identified (step 210). One or more community of practice managers may be identified to organize the community of practice and to facilitate and moderate interaction among participants. One or more experts may be associated with the community of practice. In addition, relevant documentation may be identified and collected. For example, existing design guides, training materials, tools, standards, and regulations may be added to the knowledge database (or alternatively, be made available through the document management system). Depending on the roles of various participants in the community of practice, security levels and requirements may also be established. Responsibilities of an expert may include approving knowledge entries submitted by users or periodically answering questions posted via the community of practice. Responsibilities of a manager may include approving knowledge entries submitted by users, organizing interaction between participants in the community of practice, and encouraging participants to work towards the achievement of the goals of the community of practice. It may also be determined to what extent users may participate, and whether different users may have different access to knowledge database. Participants in the community of practice may, if appropriate, receive training in order to enhance their usage of the community of practice.

Goals for the community of practice are then determined (step 220). The goals of the community of practice may include the goals or purposes for which the community of practice was formed. For example, goals may be product-oriented, such as creating a design guide for a new product or developing a software product for testing a new product. Goals may also be information-oriented, such as distributing information from recent symposia or meetings or collecting feedback from organizational locations worldwide to determine required improvements. Further, goals may be career-oriented, such as developing training programs for new employees and providing networking between persons in the organization. Another method for determining goals for the community of practice includes determining what knowledge is missing or what knowledge should be updated. The goal of a community of practice, as encompassed by the present invention, is not the mere cataloging of information within an organization nor the mere answering of questions.

FIG. 5 is an exemplary flowchart illustrating a method for capturing, managing, and sharing knowledge in an established community of practice. Once a community of practice is established, the community of practice is opened (step 300). The community of practice may be advertised within the organization, for example, via company newsletters, e-mails, or other media. Persons wishing to join a community of practice may be asked to enroll or subscribe in the community of practice. There may be different levels of membership, each having a level of security associated. Alternatively, all users may have access to all parts of the knowledge database associated with the community of practice.

The community of practice then may capture new knowledge (step 310). New knowledge may be submitted by users, or may be gathered from interactions (for example, via electronic bulletin board or other collaborative tool) between users via knowledge management architecture 105. Knowledge may include explanations of a situation, commentary on a situation, suggestions for improving a situation, links or references to supporting material, or suggestions of persons who may have additional knowledge. Knowledge may also include information about the person supplying the knowledge. Knowledge may be left in its original format, including word processing, spread sheet, or presentation format. Knowledge that is not in electronic format may be scanned to create an electronic document that may then be attached to electronic mail or messages. By leaving knowledge in the original format, the substance can be reviewed and fine-tuned prior to any conversion.

Next, the captured knowledge is reviewed (step 320). The knowledge may be reviewed to determine if the material is accurate, complete, and/or validated. The knowledge entry may be reviewed by the community of practice manager and/or the expert. Alternatively, the knowledge entry may be reviewed by a review team consisting of a number of persons and resources from within the organization or community of practice.

Once the knowledge entry has been approved, it is delivered (step 330). Delivery of knowledge may include e-mailing the entry to all users who have subscribed to the community of practice. Alternatively, the knowledge entry may be made available for browsing via a Web site associated with the community of practice. Delivered knowledge may also include information about validation and future plans. Further delivered knowledge may include the capability to comment on the knowledge, as well as links to obtain more information or related knowledge. The delivered knowledge may have the capability to be forwarded to non-community of practice members.

Finally, knowledge entries are maintained and/or archived (step 340). Specifically, knowledge entries, such as standards, design guides, training materials, or other procedural information may be validated and updated based on the new knowledge entries. Maintenance of these knowledge entries may include version tracking or other organizational procedures to ensure that the current documents and procedures are being followed. Knowledge entries may also be archived for later use.

The community of practice may also be monitored based on standard metrics, such as usage (such as number of times the knowledge database is accessed), time to market, or other criteria. Once it has been determined that the goals or purposes of the community of practice have been achieved, the community of practice can function as an effective resource for the organization.

### Alternative Embodiments

As explained, the disclosed embodiments enable knowledge to be be centralized such that it is accessible by anyone in an organization. Consistent with these embodiments, methods and systems are disclosed that manage knowledge documents (e.g., files, text documents, graphical documents, etc.) to enable communities of practice to selectively share knowledge documents, while reducing the amount of resources needed to maintain the knowledge documents.

Exemplary Community of Practice Environments

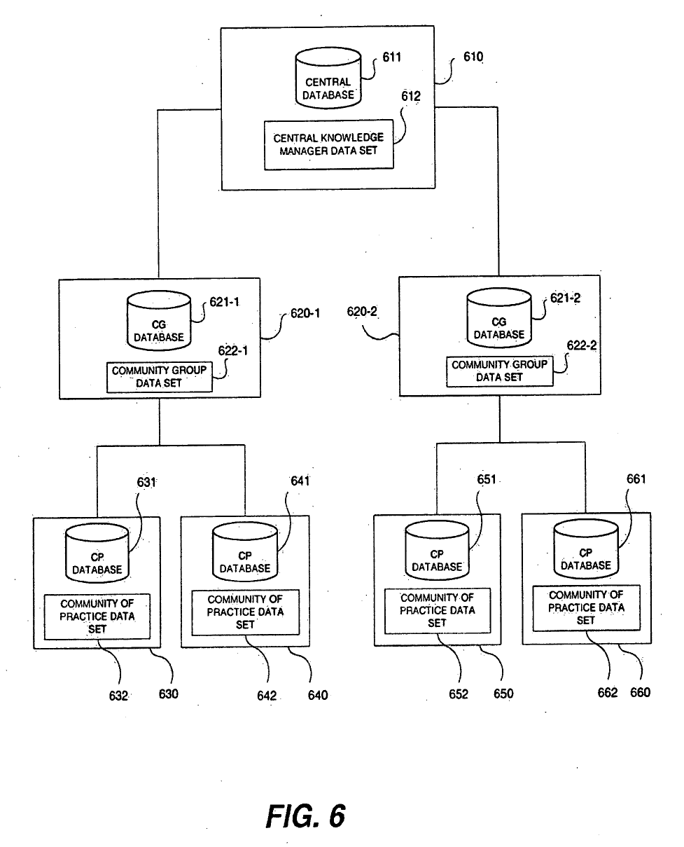

FIG. 6 shows a block diagram of an exemplary community of practice knowledge document environment consistent with certain disclosed embodiments. As shown, the environment may include a knowledge management (KM) coordinator 610, one or more community of practice groups (CG) 620-1 and 620-2, and one or more communities of practice (CP) 630, 640, 650, and 660.

KM coordinator 610 may correspond to a computer system that is accessed by a KM coordinator, such as the knowledge management coordinator 195 described above in connection with FIG. 3. The KM coordinator may be one or more persons that have access rights to information managed by KM 610. CGs 620-1 and 620-2 may each correspond to a computer system associated with a community groups, such as the community groups 196 described above in connection with FIG. 3. CPs 630-660 may each correspond to a computer system associated with a community of practice, such as the communities of practice described in the above disclosed embodiments.

Each computer system associated with a community entity (e.g., KM coordinator 610, CGs 620, and CPs, 630-660) may include known computer system components that enable the respective entity to perform computer processing functions, such as a processor, memory device, input/output devices, network interfaces, etc. In one embodiment, KM coordinator 610 may include a central database 611 and a central KM data set 612. Similarly, CGs 620-1 and 620-2 may include a CG database 621-1, 622-2, and a CG dataset 622-1 and 622-2, respectively. Further, each CP 630-660 may include a CP database 631, 641, 651, and 661, and a CP dataset 632, 642, 652, and 662, respectively. Each database 611, 621-1, 621-2, 631, 641, 651, and 661 may be one or more memory devices that store information consistent with certain disclosed embodiments, such as knowledge documents. Each dataset 612, 622-1, 622-2, 632, 642, 652, and 662 may represent one or more data structures stored in a memory device, such as any one of databases 611, 621-1, 621-2, 631, 641, 651, and 661, or a separate memory device (not shown). Data sets 612, 622-1, 622-2, 632, 642, 652, and 662 may include information reflecting the type of data associated with a particular entity in the environment shown in FIG. 6. For example, the data sets 612, 622-1, 622-2, 632, 642, 652, and 662 may each include data reflecting a correlation between knowledge documents and a particular community entity shown in FIG. 6, such as KM coordinator 610, CGs 620-1, 620-2, and CPs 630-660. Additionally, data sets 612, 622-1, 622-2, 632, 642, 652, and 662 may include data that reflects a correlation between members of a CP and/or CG and other information, such as knowledge documents. For example, data sets 612, 622-1, 622-2, 632, 642, 652, and 662 may include access control lists that control which members have access to particular information, such as knowledge documents. These access control lists may also control which community entities (e.g., KM coordinator 610, CGs 620-1, 620-2, and CPs 630-660) have access to particular information, such as knowledge documents, other access control lists, data sets 612, 622-1, 622-2, 632, 642, 652, and 662, etc.

Although FIG. 6 shows a selected number of community entities, the disclosed embodiments are not limited to this exemplary configuration. Any number of KM coordinators 610, CGs 620, and CPs 630-660 may be implemented. Further, the interconnections shown in FIG. 6 are not intended to be limiting, but are illustrated in an exemplary configuration. Each community entity may interface with one or more networks that enable data to be exchanged between one or more of the community entities, such as network 140 described above in connection with FIG. 1.

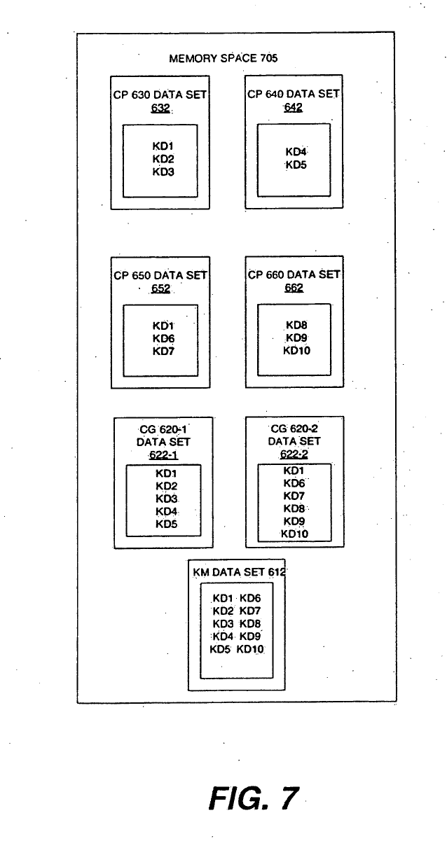

As mentioned above, data sets 612, 622-1, 622-2, 632, 642, 652, and 662 may include information that reflects a relationship between a community entity and/or CP members and knowledge documents. In one embodiment, each data set may include data set information respective to a corresponding community entity. For example, CP data set 632 may include data set information for CP 630, while CP data set 652 may include data set information for CP 650. In other embodiments, data sets 612, 622-1, 622-2, 632, 642, 652, and 662 may be stored in a common memory space accessible by a processor and by each of the community entities in the community of practice environment. FIG. 7 illustrates a block diagram of an exemplary memory space 705 consistent with certain embodiments. Memory space 705 may include data sets 612, 622-1, 622-2, 632, 642, 652, and 662. In one embodiment, memory space 705 may be located in central KN database 611. In other embodiments, one or more, or all, of community entities 610, 620-1, 620-2, and 630-660 may include memory space 705 in their respective databases. Alternatively, different community entities may include different portions of the information stored in memory space 705. For example, central KM database 611 may include memory space 705 and the data set information stored therein. CGs 620-1 and 620-2, however, may include a memory space having data set information corresponding to their respective community groups. Thus, CG 620-1 may include in its memory space only data sets 622-1, 632, and 642, while CG 620-2 may include in its memory space only data sets 622-2, 652, and 662. Other configurations for storing data set information may be implemented and the above examples are not intended to be limiting to the disclosed embodiments.

In certain disclosed embodiments, methods and systems are provided that enable a CP member to provide and gain access to knowledge documents. Embodiments manage access to knowledge documents depending upon various configurations of the community of practice environment. In certain embodiments, knowledge documents are maintained in a central location that are accessible by entities and/or members having the proper authorization. In another embodiment, knowledge documents may be distributed, with only one copy of the document maintained in a memory device, but accessible by all authorized entities and members, although backup copies of such documents and information is contemplated for fault recovery purposes.

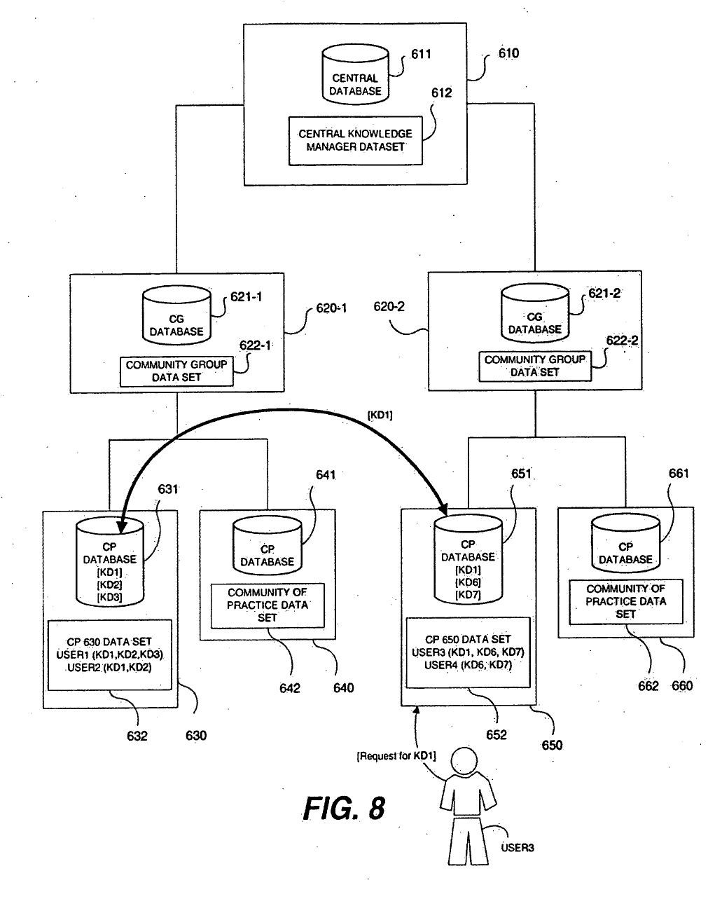

FIG. 8 illustrates a block diagram process consistent with these embodiments based on the community of practice environment shown in FIG. 6. As shown, CP database 631 includes three knowledge documents KD1, KD2, and KD3, which are associated with the community of practice relating to CP 630. CP data set 632 includes data set information reflecting CP 630's management of these documents (i.e., listing which knowledge documents are included in CP 630). Further, CP data set 632 may identify access control data reflecting which members of CP 630 (e.g., user1 and user2) have access to particular knowledge documents. As shown in this example, user1 has access to all knowledge documents KD1, KD2, and KD3, while user 2 has access to only KD2 and KD3. FIG. 8 also shows CP database 651 including knowledge documents KD1, KD6, and KD7 and CP data set 652 includes corresponding data set information reflecting access control data for members user3 and user4 of CP 650. Both users 3 and 4 have access to knowledge documents KD6 and KD7. User3, however, also has access to KD1.

In the exemplary configuration shown in FIG. 8, users 1 and 2 may request and retrieve knowledge documents KD1, KD2, and/or KD3 from CP 630 and CP database 631. Similarly, users 3 and 4 may request and receive knowledge documents KD6 and KD7 from CP 650 and CP database 651. Further, user3 may request KD1 from CP 650. In certain embodiments, CP 630 may issue a request for KD1 to CP 630 based on information in CP data set 652 identifying which community entity hosts that document. As such, CP 630 may provide KD1 to CP 650 for delivery to user3. In one embodiment, CP 630 may perform the authorization checks to determine whether CP 650 and/or user3 has authority to access KD1 based on information stored in CP data set 632, such as fields or attribute data identifying access rights for that document. Alternatively, CP 630 and CP 650 may distribute the authorization checking processes. For example, CP 650 may initially check the authority for user3 to access KD1, and CP 630 may determine whether CP 650 has rights to KD1. Other configurations for checking the authority of a community entity and/or member's rights to a knowledge document may be implemented by the disclosed embodiments.

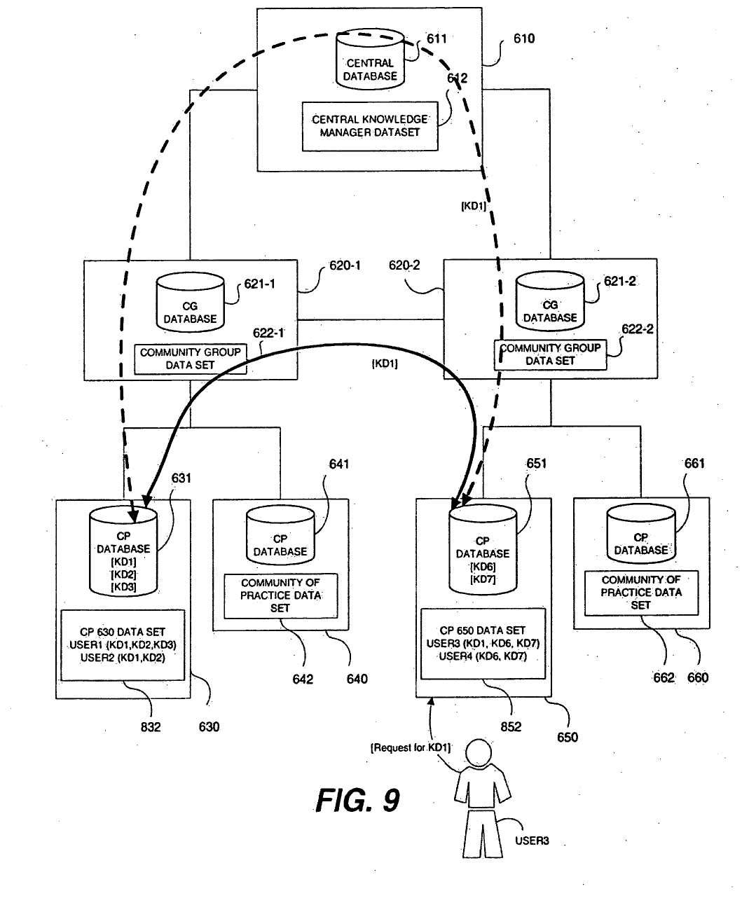

In another embodiment, CG 620-1 and/or 620-2, or KM coordinator 610 may manage the flow of knowledge documents between CPs 630-660. FIG. 9 shows an example of such a configuration. For instance, CP 650 may receive the request for KD1 from user 3. CP 650 may forward the request to its corresponding CG 620-2. In response, CG 620-2 may either send a broadcast message to other CGs or KM coordinator 610 for the document. The host of KD1, which is CP 630 in this example, may send a response identifying itself as the host or may send a copy of KD1 to CG 620-2 for delivery to user3 via CP 650. Alternatively, CG 620-2 may include information in CG data set 622-2 that identifies CP 630 as the host of KD1. In this embodiment, CG 620-2 may issue the request for KD1 to CG 620-1, which retrieves KD1 from CP 630 for subsequent delivery to user 3 via CG 620-2 and CP 650. Alternatively, as shown as the dotted process flow in FIG. 9, CG 620-2 may forward the request for KD1 to KM coordinator 610 for retrieving and delivering KD1 to user 3 via CG 620-2 and CP 650. Other request and delivery processes may be implemented based on the configuration of the community of practice environment and associated infrastructure supporting the environment.

In another embodiment, knowledge may be stored centrally in a community group or in KM coordinator 610. In these embodiments, requests for a knowledge document may be directed from the CP receiving the request to the community entity storing the knowledge documents. For example, CG 620-1 may store all knowledge documents for its community group (e.g., all knowledge documents included in CPs 630 and 640) and CG 620-2 may store all knowledge documents for its corresponding community group (e.g., all knowledge documents included in CPs 650 and 660). In another example, KM coordinator 610 may store all knowledge documents for the entire CP environment. As such, requests for knowledge documents are directed to KM coordinator for delivery to the appropriate CP requesting the document(s).

Membership to a Community of Practice

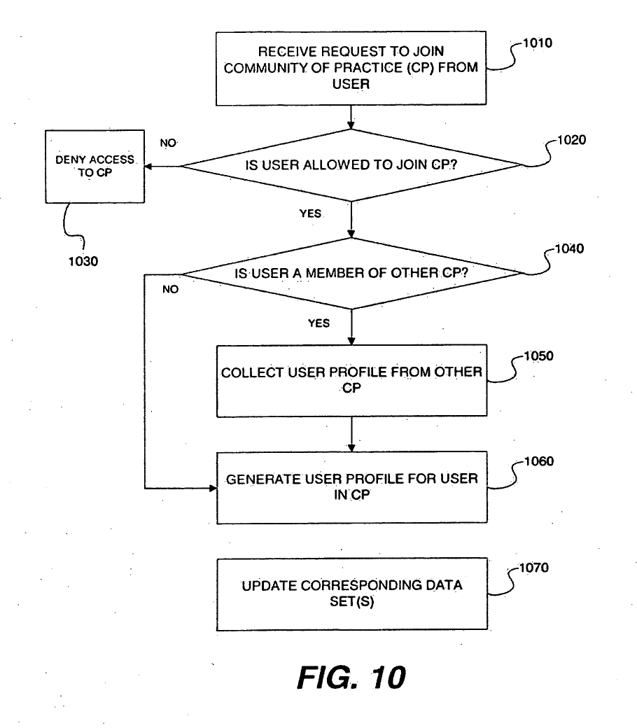

As explained, certain embodiments enable a person of an organization (or outside an organization) to join a community of practice. As such, the data sets for a CP, CG, and KM coordinator must be updated. Certain embodiments employ user profiles that enable community entities to manage one or more communities of practice, such as KM coordinator, which may be associated with knowledge management architecture 105. FIG. 10 shows a flowchart of an exemplary user profile generation process consistent with certain embodiments. For instance, as previously mentioned, a community of practice may be advertised via various communication mediums (e.g., e-mail, company newsletters, etc.). In response, KM coordinator 610, or another community entity, may receive a request to join a particular CP from a user (Step 1010). Based on the request, KM coordinator 610 may determine whether the user is allowed to join the CP (Step 1020). This process may include reviewing information in the request (e.g., purpose for joining, etc.) and other information, such as the user's credentials, etc., by a review panel (e.g., a manager, expert, etc.). Alternatively, the review may be performed by a software process executed by a computer that compares certain data with template data to determine whether the user is allowed to join the CP. Further, KM coordinator 610 may forward the request to a corresponding CG or CP for review. If the user is not allowed to join the CP (Step 1020; No), KM coordinator 610 (or the reviewing community of practice entity) may deny access to the CP (Step 1030) and possibly notify the user using any form of communication media, such as e-mail, letters, telephone, pager text messages, etc.

On the other hand, if the user is allowed to join the CP (Step 1020; Yes), KM coordinator 610 may determine whether the user is a member of another CP (Step 1040). This may be performed by a computer executed process that allows a reviewer (person or software process) to search data set information for all CPs in a CP environment. If the search reveals the user is not a member of any CP, the process continues to step 1060. If the user is a member of another CP (Step 1040; Yes), KM coordinator may collect user profile data from the other CP (Step 1050). The user profile data may include user credentials, job responsibilities, contributions of knowledge (e.g., knowledge documents, or other forms of knowledge), etc. KM coordinator 610 may then generate a user profile for the requested CP (Step 1060) and store the information in a user profile database, which may include KM data base 611. Further, KM coordinator 610 may update the appropriate data sets corresponding to the CP identifying the user as a member and the user's rights to access selected knowledge within the requested CP (Step 1070). For example KM coordinator 610 may update KM data set 611 and direct the CG associated with the requested CP to update its respective data set. Further, the request CP may update its associated data set with the new member's information. In one embodiment, the user profile information obtained from the other CP, from which the user may be a member, may include data set information reflecting access rights to knowledge, such as knowledge documents. Accordingly, the community entity may update its corresponding data set based on this information.

Updating Data Sets with New Knowledge

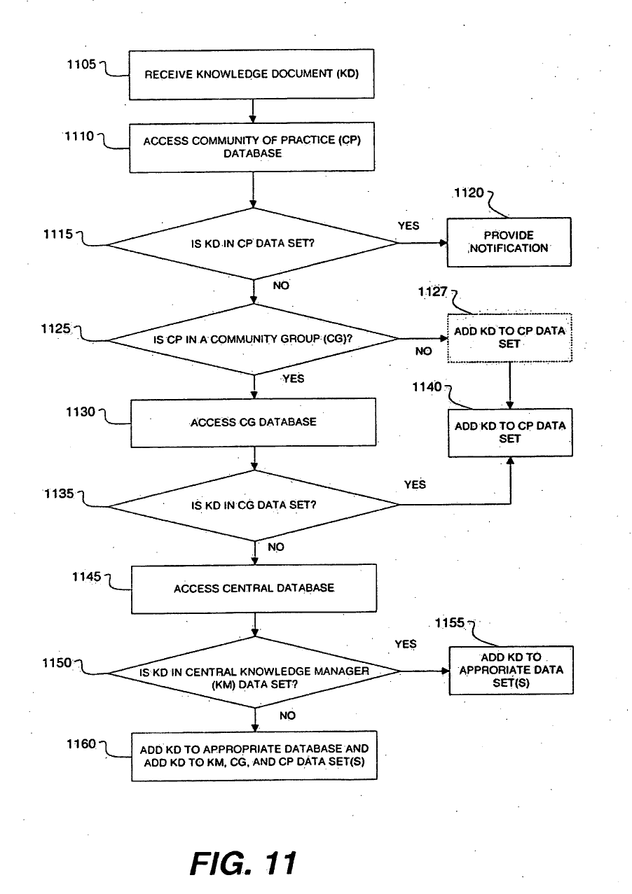

Disclosed embodiments also enable community entities to update data sets based on new knowledge provided by a member of a community of practice. FIG. 11 shows a flowchart of an exemplary knowledge updating process consistent with certain embodiments. To describe the exemplary processes associated with these embodiments, reference is made to the community of practice environment shown in FIG. 6. It should be noted, however, the reference to particular community entities is not intended to be limiting to the disclosed processes.

At some point during a community of practice's life span (e.g., the time from inception until the community of practice has reached is assigned goal(s)), a member may request to share knowledge with other members of a community of practice to assist the community to achieve one or more of its goals. For example, CP 630 may receive a knowledge document (KD) from a member (Step 1105). In response, CP 630 may access CP database 631 (Step 1110) to determine whether the KD is already identified in CP data set 632. If so (Step 1110; Yes), CP 630 may provide notification to the user indicating the existence of the KD in CP 630 and a copy of the KD already available to authorized members of the CP (Step 1120). If the KD is not in CP data set 632 (Step 1110; No), CP 630 may determine whether it is included in a community of practice group, such as CG 620-1 (Step 1125). If not, in one optional embodiment, CP 630 may then add the new KD to CP data base 631 (Step 1127.) It should be noted that step 1127 is shown in FIG. 11 as a dotted box, representing this process step is optional. In alternative embodiments where knowledge documents are maintained in other central locations, such as databases 621-1 or 611, CP 630 may forward the KD for appropriate storage. CP 630 may also add the new KD to CP data set 632 and update any appropriate access control data for members of CP 630 with respect to the newly added KD (Step 1140).

On the other hand, if CP 630 is a member of a CG (step 1125; Yes), CP 630 may generate and send a message to the appropriate CG, which in this example, is CG 620-1 identifying the request to add KD to CP 630. In response, CG 620-1 may access CG database 621-1 (Step 1130) to determine whether the KD is included in CG data set 622-1 (Step 1135). This process step enables CG 620-1 to determine whether any other CPs in the community of practice group has the KD included in their respective data sets, and thus reflecting a copy of the KD in the community of practice environment. If the KD is identified in CG data set 622-1 (Step 1135; Yes), CG 620-1 may notify CP 630, which in turn adds KD to CP data set 632 (Step 1140).

If, however, the KD is not included CG data set 622-1, thus indicating that no CP within the community group includes the KD, CG 620-1 may generate and send a message to KM coordinator 610 indicating the request to add KD to CG 620-1 and/or CP 630. In response, KM coordinator 610 may access central KM database 611 (Step 1145) to determine whether the KD is included in central KM data set 612 (Step 1150). If so (Step 1150; Yes), KM coordinator 610 realizes that some other community group (and therefore, another CP) includes the KD, and thus a copy of the KD is present in the community of practice environment. Accordingly, KM coordinator 610 adds KD to its KM data set 612 and directs CG 620-1 to add the KD to its data set 622-1 and CP 630 to add KD to its data set 632 (Step 1155). However, if the KD is not in KM data set 612 (Step 1150; No), KM coordinator 610 may add the KD to an appropriate database (e.g., KM database 611, CG database 621-1, or CP database 632) and adds the KD to KM data set 612, CG data set 622-1, and CP data set 632 (Step 1160).

Accessing Knowledge

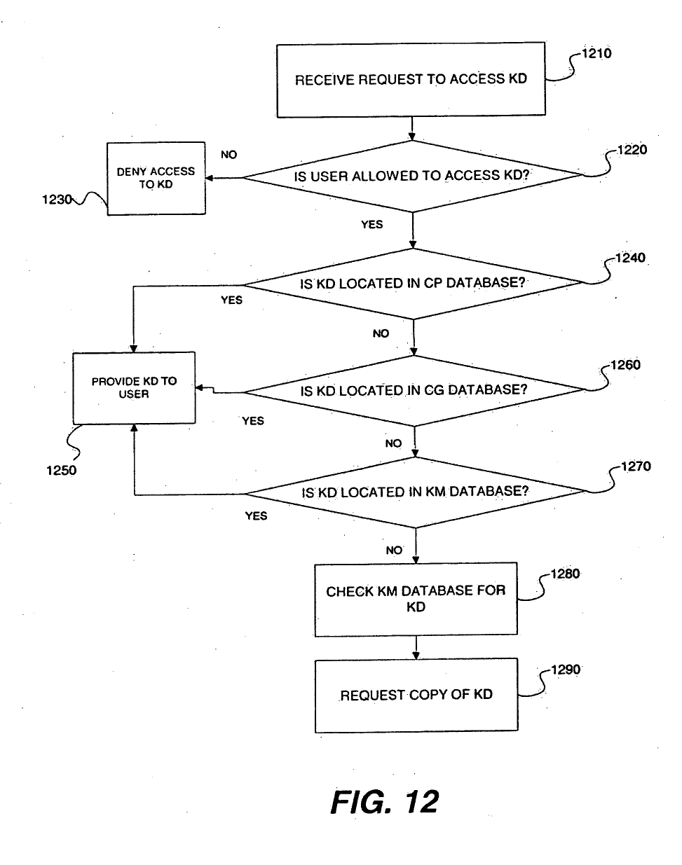

As explained, methods and systems consistent with certain disclosed embodiments enable a member to request and receive knowledge from a corresponding community of practice. FIG. 12 shows a flowchart of an exemplary knowledge document delivery process consistent with certain embodiments. To describe the exemplary processes associated with these embodiments, reference is made to the community of practice environment shown in FIG. 8. It should be noted, however, the reference to particular community entities is not intended to be limiting to the disclosed processes.

Initially, a CP receives a request to access a KD from a user who is a member of the CP (Step 1210). For exemplary purposes, CP is associated with CP 650 and the user with user3 requesting access to KD1, as shown in FIG. 8. Based on the request, CP 650 may determine whether user3 is allowed to access the requested KD (Step 1220). In one embodiment, CP 650 may analyze the data set information stored in CP data set 652 to determine whether access control information indicates user3 is allowed access to KD1. If user3 is not allowed access to the requested KD (Step 1220; No), access is denied and the user notified (Step 1230). If, however, access is allowed (Step 1220; Yes), CP 650 may determine whether the KD is stored locally in CP database 651 (Step 1240). If it is (Step 1240; Yes), CP 650 retrieves KD1 from its database and delivers the knowledge document to user3 using known data delivery mechanisms, such as e-mail, electronic file delivery via a Web browser and network transmission protocols, hard copy delivery, etc. (Step 1250).

On the other hand, if KD1 is not located in CP database 651, CP 650 may issue a request to CD 620-2 to determine whether KD1 is lcoated in CG database 621-2 (Step 1260). If it is, CG 622-1 retrieves the knowledge document and delivers it to CP 650 for subsequent delivery to user3 (Step 1250.) However, if CG 620-1 determines KD1 is not stored in CG database 622-2 (Step 1260; No), CG 620-2 may issue a request to KM coordinator 621 to determine which community entity stores KD1. In response, KM coordinator 610 determines whether KD1 is located in KM database 611 (Step 1270). If so, KM coordinator 610 delivers KM1 to CP 650 (directly or indirectly via CG 620-2) for transmission to user3 (Step 1250). On the other hand, if KD1 is not located in KM database 611 (Step 1270; No), then KM coordinator 610 may check KM data set 612 to determine whether KD1 is included in the community of practice environment (Step 1280). If not, KM coordinator 610 may issue a notification message to CP 650 for delivery to user3 indicating that the document is not stored in the community of practice environment. Further, KM 610 may initiate a rectification process that issues requests to all community entities to determine which entities include KD 1 within its data sets, in order to determine the source of the discrepancy of the request. That is, KM coordinator 610 performs or initiates processes that determines a reason for a knowledge document being included in a community entity data set, yet no copy of the document is available. This process may include sending a broadcast message to all community entities to determine whether an entity or member has a copy of the missing document. If an entity or member has a copy of the missing document, KM coordinator 610 may request for a copy of the KD (Step 1290). In one embodiment, a member may provide the knowledge document for inclusion in a CP in a manner consistent with the disclosed embodiments described above.

### INDUSTRIAL APPLICABILITY

Knowledge management using the community of practice system and method of the current invention provide a way to permit interaction and collaboration between persons who have knowledge and persons who are seeking knowledge. The present invention supports internal collaboration among team members in an open environment that encourages participation. Further, the present invention provides for documentation of the knowledge, so that the knowledge is available globally and can be easily identified by those who are seeking it. Other benefits of the present invention include the ability to maintain up-to-date standards and best practices, the ability to quickly train new employees, and the ability to collaborate on an organization-wide level. Up-to-date standards and practices can be kept in a central electronic location, accessible by anyone in the organization, and when updates are required, suggestions can be solicited through the community of practice. New employees can be quickly trained, as all of the tools, standards, best practices, and training material are also available in one location. New employees also have the ability to interact with other employees to answer any questions that might arise. Collaboration on an organization-wide level is possible because e-mails containing new knowledge may be routed immediately to all members of the community of practice, while all tools and other materials are available in one location.

The present invention has clear benefits in helping divisions within an organization share information. For example, one division of a company may have identified a problem, but due to time or budget constraints, was unable to create a software program to analyze the problem. A second division of the company had created a spread sheet tool to analyze the problem; however, the tool was stored locally within the second division and was not accessible to the rest of the company, including the division that had identified the problem. In accordance with an embodiment of the present invention, a user in the second division may have submitted the tool to the community of practice where it was reviewed by experts and approved for use throughout the company. Since putting the tool into use, the tool may have been modified by various users in the community of practice based on their experiences. Thus, the division experiencing the problem would have this valuable corporate resource to draw upon.

As another example of the effective use of the present invention, a user in one division of an organization may post a question to an electronic bulletin board associated with the community of practice. In reply, the user may receive responses from persons throughout the organization. Some of the responses may provide answers or suggestions to the user's question; other responses may direct the user to a person knowledgeable about the topic or may direct the user to documentation existing in the knowledge database.

The community of practice system and method of the present invention has virtually unlimited potential uses. A community of practice may be established whenever there is a business requirement. In certain organizations, this may require notifying and obtaining support from a corporate coordinator. Once necessary approvals are obtained, a community of practice manager, associated experts, and any procedures, specifications, training, and standards that the community of practice would be responsible for are identified. Security levels and requirements would be determined for the community, as well as specific goals for the community to accomplish. Training may be provided as necessary for the community. The community of practice would then be opened in the organizational knowledge management system. Once the new community of practice is advertised, membership and subscriptions of users would be accepted. The progress of the community of practice can be measured with standard metrics. Once the original goals are achieved, the community of practice will continue to be an effective corporate resource.

Methods and systems consistent with the disclosed embodiments may be applied to community of practice environments to allow knowledge to be shared and distributed among community entities. These embodiments help reduce the amount of resources required to maintain knowledge in a community of practice environment that includes multiple communities and/or community groups. Accordingly, members of a community of practice may provide knowledge to a community of practice and the community environment will store the knowledge in a location that is accessible by all members and community entities that have proper authorization. Further, in response to a request for a knowledge document, methods and systems may locate and delivery the document using the distributed and knowledge sharing configurations disclosed herein. Further, it should be noted that knowledge documents may represent any type of knowledge that may be configured in a tangible form, such as a data file, executable software code, a text document, graphic documents or files, HTML code, Web pages, Web hyperlinks, etc. As such, the disclosed embodiments are not limited to any particular type of knowledge document.

Other aspects and features of the present invention can be obtained from a study of the drawings, the disclosure, and the appended claims.

What is claimed is:

1. A system for managing knowledge documents in a community of practice environment, comprising:
a first community of practice, including as members, first users, first one or more experts, and first one or more community of practice managers, and including a community of practice database storing a first community of practice data set identifying a first knowledge document as being assigned to the first community of practice;
a second community of practice including as members, second users, second one or more experts, and second one or more community of practice managers, and including a second community of practice database storing a second community of practice data set identifying the first knowledge documents as being assigned to the second community of practice,
wherein the first community of practice delivers the first knowledge document to the second community of practice in response to a request for the first knowledge document from a first member of the second community of practice.

2. The system of claim 1, wherein the second community of practice uses the second community of practice data set to determine whether the first member is authorized to access the first knowledge document.

3. The system of claim 1, wherein the first community of practice determines whether the first member is authorized to access the first knowledge document.

4. The system of claim 1, wherein both the first and second communities of practice are configured to receive a respective request to add a new knowledge document to the respective community of practice, and in response to the request, to add the new knowledge document, and determine whether a copy of the new knowledge document is stored in the respective community of practice database.

5. The system of claim 1, wherein the first and second communities of practice are included in a community of practice group, and wherein instead of the first community of practice delivering the first knowledge document, the community of practice group delivers the first knowledge document to the first member.

6. The system of claim 1, wherein the first and second communities of practice are included in respective first and second community of practice groups.

7. The system of claim 6, wherein instead of the first community of practice delivering the first knowledge document, a knowledge management coordinator that manages the first and second community of practice groups delivers the first knowledge document to the first member.

8. The system of claim 1, wherein the first community of practice database stores the first knowledge document.

9. A community of practice environment, including:
a set of communities of practice, each including respective members and each being assigned respective knowledge documents; and
a database system storing the knowledge documents used by the communities of practice, wherein the database system is configured to deliver copies of the knowledge documents to the communities of practices in response to requests to access the knowledge documents from respective community of practice members.

10. The system of claim 9, wherein each community of practice includes a community of practice data set that identifies which knowledge documents are assigned to the community of practice.

11. The system of claim 9, wherein the database system is included in a community of practice group that includes the set of communities of practice.

12. The system of claim 9, wherein the database system is included in a knowledge management coordinator system that manages the community of practice environment, which includes one or more community of practice groups that is assigned a portion of the set of communities of practice.

13. A method of managing a community of practice environment including communities of practice, each assigned particular knowledge documents, including:
receiving a request from a member of a first community of practice for a first knowledge document included in a first set of knowledge documents assigned to the first community of practice; and
retrieving by the first community of practice, the knowledge document from a community entity included in the community of practice environment.

14. The method of claim 13, wherein receiving the request includes:
determining whether the member is authorized access to the knowledge document.

15. The method of claim 13, wherein retrieving includes:
retrieving by the first community of practice, the knowledge document from a second community of practice assigned a second set of knowledge documents including the first document.

16. The method of claim 13, wherein retrieving includes:
retrieving by the first community of practice, the knowledge document from a central knowledge management system including a database storing all knowledge documents assigned to the communities of practice.

17. The method of claim 13, further including:
receiving a request from the member to add a new knowledge document to the first community of practice;
determining, by the first community of practice, whether the new knowledge document is assigned to the first community of practice;
determining, by the community entity, whether the new knowledge document is assigned to the community entity; and
assigning the new knowledge document to at least the first community of practice and storing the knowledge document in the community of practice environment based on the determinations by the first community of practice and the community entity that the new knowledge document is not assigned.

18. A method of managing a community of practice environment including community entities, which includes at least a first community of practice, comprising:
receiving a request from a member of the first community of practice to add a new knowledge document to the first community of practice;
determining, by the first community of practice, whether the new knowledge document is assigned to the first community of practice;
determining, by a first community entity, whether the new knowledge document is assigned to the first community entity based on the determination by the first community of practice;
assigning the new knowledge document to at least the first community of practice; and
storing the new knowledge document in the community of practice environment based on the determinations by the first community of practice and the first community entity that the new knowledge document is not assigned, wherein the new knowledge document is stored such that it is accessible by all of the community entities in the community of practice environment.

19. The method of claim 18, wherein determining by the first community of practice includes:
analyzing a first community of practice data set that includes information identifying all knowledge documents assigned to the first community of practice.

20. The method of claim 18, wherein the first community entity is a community of practice group including at least the first community of practice, and wherein determining, by the first community entity, includes:
determining whether the new knowledge document is assigned to the first community entity based on the determination that the new knowledge document is not assigned to the first community of practice.

21. The method of claim 20, wherein determining by the first community entity includes:
analyzing a first community entity data set that includes information identifying all knowledge documents assigned to any community of practice included in the community of practice group.

22. The method of claim 18, wherein assigning the new knowledge document to at least the first community of practice includes:
adding the new knowledge document to a first community of practice data set that includes information identifying all knowledge documents assigned to the first community of practice.

23. The method of claim 18, wherein assigning the new knowledge document includes:
assigning the new knowledge document to any community entity in the community of practice environment that has a relationship with the first community of practice.

24. The method of claim 18, wherein storing the new knowledge document includes:
storing the new knowledge document in the first community entity, wherein the first community entity is a central knowledge management system that manages all knowledge documents assigned to the community entities of the community of practice environment.

25. A method for managing knowledge documents in a community of practice environment including communities of practices, comprising:
assigning knowledge documents to respective communities of practice, each community of practice including members that use the knowledge documents to achieve a goal of the community of practice and a computer system that stores information reflecting the knowledge document assignments; and
storing the knowledge documents in a memory space accessible by each of the communities of practice.

26. The method of claim 25, wherein the memory space is located in a knowledge management system that manages the communities of practice.

27. The method of claim 25, wherein each community of practice includes a database and the memory space is distributed across the databases of the communities of practice.

28. The method of claim 25, wherein storing the knowledge documents includes:
storing a first set of knowledge documents in a first database of a first community of practice; and
storing a second set of knowledge documents in a second database of a second community of practice.
